(19) United States
(12) Patent Application Publication
(10) Pub. No.: US 2005/0154818 A1
(43) Pub. Date: Jul. 14, 2005

(54) METHOD OF ACCESSING A NONVOLATILE MEMORY

(76) Inventor: Ping Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,445

(22) Filed: Mar. 4, 2004

(30) Foreign Application Priority Data
Jan. 13, 2004 (TW) 093100738

(51) Int. Cl. G06F 12/08

(52) U.S. Cl. 711/103; 711/203

(57) ABSTRACT

A method of accessing a nonvolatile memory installed in an electronic device and having a plurality of zones, has the following steps: (a) store the look up table of each zone in at least a spare block; (b) the electronic device obtains one of the zones of the nonvolatile memory corresponding to a logic address of a host for accessing the nonvolatile memory; (c) the electronic device reads the look up table of the zone obtained in step (b) from at least one of the spare blocks and stores the look up table in a memory of the electronic device; and (d) the host accesses the nonvolatile memory according to the look up table stored in the memory of the electronic device.

### BACKGROUND OF INVENTION

1. Field of the Invention

The present invention relates to a method of accessing a nonvolatile memory, and more particularly, to a method of accessing the nonvolatile memory in accordance with preconstructed look up tables of all zones of the nonvolatile memory.

2. Description of the Prior Art
flash memory has advantages of a nonvolatile characteristic and low power consumption, and therefore is broadly applied to a variety of electronic devices. Due to its specific erase method, look up tables are required to access different zones of the flash memory. Normally, the flash memory is divided into a plurality of zones, and each zone needs a corresponding look up table. Consequently, a high capacity flash memory requires many look up tables. Compared with the time of reading or writing the flash memory, the time of constructing a look up table is much longer.

Each zone of the flash memory is composed of 1024 blocks, where 1000 blocks are used to store data and the remaining 24 blocks serve as spare blocks. Since the flash memory can only be written from “1” to “0” rather than from “0” to “1”, the spare zones are required to store new data. The original look up table is therefore changed so that the logic address of old data corresponds to the spare block where new data is stored. In conventional technologies, there are two methods of constructing the look up table of the flash memory. The first one is to construct the look up table whenever a host accesses a different zone of the flash memory. The second one is to construct the look up tables of all zones in a memory in advance before the flash memory is accessed.

Please refer to FIG. 1. FIG. 1 is a schematic diagram illustrating a host 10 connected to a flash memory 30. As shown in FIG. 1, the host 10 includes a CPU 12 and a RAM 14. The flash memory 30 is installed in an electronic device 20, and the electronic device 20 includes a controller 22 and a memory 24. The host 10 can be connected to the electronic device 20 via a USB interface (not shown). While accessing the flash memory 30, the CPU 12 sends a logic address to the controller 22, and the controller 22 will calculate the zone of the flash memory 30 corresponding to the logic address and store the look up table element of the zone in the memory 24. In such case the controller 22 can access the flash memory 30 with reference to the look up table, and deliver data to the RAM of the host 10 via the USB interface (not shown).

Please refer to FIG. 2. FIG. 2 is a flowchart illustrating the conventional steps of accessing the flash memory 30. The steps of accessing the flash memory 30 of the electronic device 20 are demonstrated as follows:

Step 110: the electronic device 20 receives a logic address of accessing the flash memory 30 from the host 10, and calculates the zone of the flash memory 30 corresponding to the logic address;
Step 120: determine if the zone corresponding to the logic address is identical to the zone corresponding to a look up table stored in the memory 24, if not, execute step 130, if so, execute step 140;
Step 130: construct a look up table of the zone corresponding to the logic address, and store the look up table in the memory 24; and
Step 140: the controller 22 accesses the flash memory 30 according to the look up table stored in the memory 24, and delivers data to the host 10.

In the course of accessing the flash memory 30, if the zone corresponding to the logic address changes, the controller 22 has to construct a new look up table of the zone, i.e. by the first method of constructing the look up table as described earlier.

Please refer to FIG. 3. FIG. 3 is a flowchart of constructing a look up table in step 130 of FIG. 2. The steps of constructing the look up table are shown as follows:
Step 210: obtain the zone corresponding to the logic address;
Step 220: read the address of each block in the zone, and store the addresses in the memory 24; and
Step 230: determine if the address of each block in the zone have been read, if so, the look up table is constructed, if not, repeat step 220.

If the second method of constructing the look up table is selected, steps 210 to 230 are repeated to construct the look up tables of all the zones of the flash memory 30 before the flash memory 30 is accessed.

It can be seen that the first method constructs the look up table of a certain zone only when the host 10 needs to access that certain zone of the flash memory 30, and thus the memory 24 stores only one look up table. Therefore, the first method is commonly adopted for saving memory space. However, since the look up table has to be reconstructed every time the zone being accessed changes, the speed of accessing the flash memory 30 is influenced. On the other hand, the second method constructs the look up tables of all zones of the flash memory 30 in advance, and stores the look up tables in the memory 24 of the electronic device 20. Consequently, the speed is improved, but the required memory space of the memory 24 is increased.

### SUMMARY OF INVENTION

It is therefore a primary objective of the present invention to provide a method of accessing a nonvolatile memory by pre-constructing the look up tables of all zones in the nonvolatile memory to solve the above problems.

According to the claimed invention, a method of accessing a nonvolatile memory is disclosed. The nonvolatile memory is installed in an electronic device and comprises a plurality of zones, each zone comprising a plurality of spare blocks, the method comprises the following steps: (a) store the look up table of each zone in at least a spare block; (b) the electronic device obtains one of the zones of the nonvolatile memory corresponding to a logic address of a host for accessing the nonvolatile memory; (c) the electronic device reads the look up table of the zone obtained in step (b) from at least one of the spare blocks and stores the look up table in a memory of the electronic device; and (d) the host accesses the nonvolatile memory according to the look up table stored in the memory of the electronic device.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram illustrating a host connected to a flash memory.

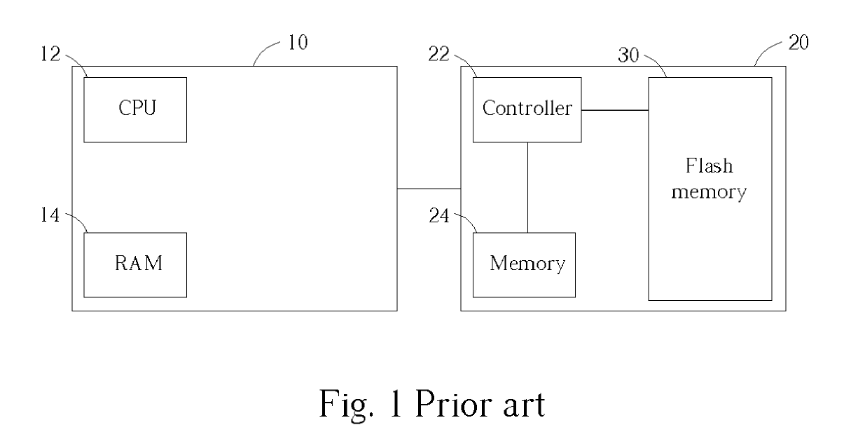

FIG. 2 is a flowchart illustrating the conventional steps of accessing the flash memory.

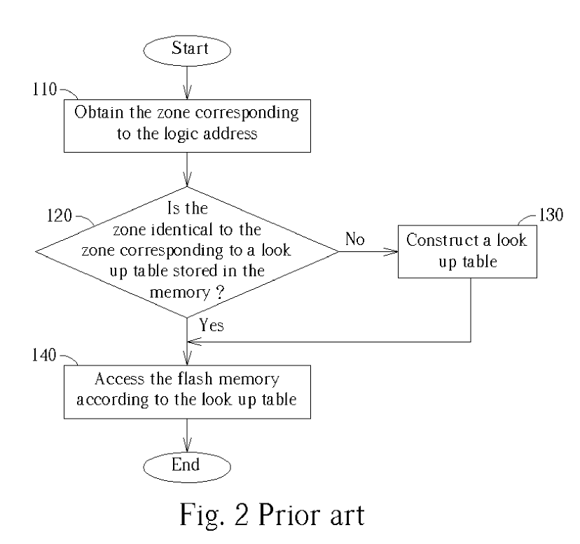

FIG. 3 is a flowchart of constructing a look up table in step 130 of FIG. 2.

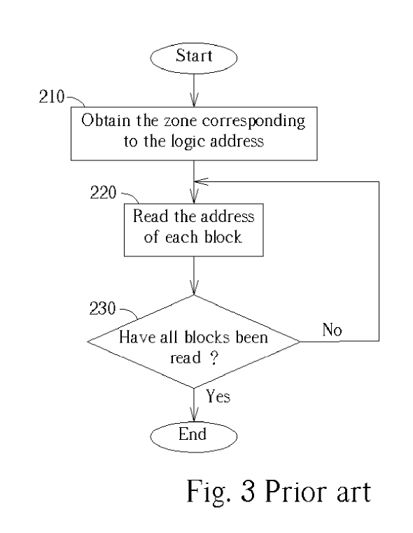

FIG. 4 is a flowchart illustrating a method of accessing the flash memory according to the present invention.

FIG. 5 is a schematic diagram illustrating how the host accesses the flash memory.

### DETAILED DESCRIPTION

In view of the disadvantages of the conventional methods of accessing a nonvolatile memory, the present invention provides a method of accessing a flash memory in which the host constructs look up tables of all zones of the flash memory in at least a spare block when the host reads the flash memory at the first time. Since the flash memory is nonvolatile, the look up tables will be kept in the spare blocks even when power is interrupted. As a result, whenever the host 10 attempts to access the flash memory 30 or changes the zones of accessing the flash memory 30, the controller 22 of the electronic device 20 only needs to read the look up table in the spare block of the flash memory 30 and store the look up tables in the memory 30 so that the time of constructing a new look up table is saved. In addition, since each zone of the flash memory 30 has spare blocks, the look up table of each zone can be correspondingly stored in the spare block of the corresponding zone. Alternatively, the look up tables of all zones can also be stored in the spare blocks of one certain zone. According to the present invention, the controller 22 only has to construct the look up tables once and store the look up tables in the spare blocks, and the then read the look up tables stored in the spare blocks of the flash memory 30 whenever the host 10 changes the zone of accessing the flash memory 30. Consequently, the speed of accessing the flash memory 30 is improved.

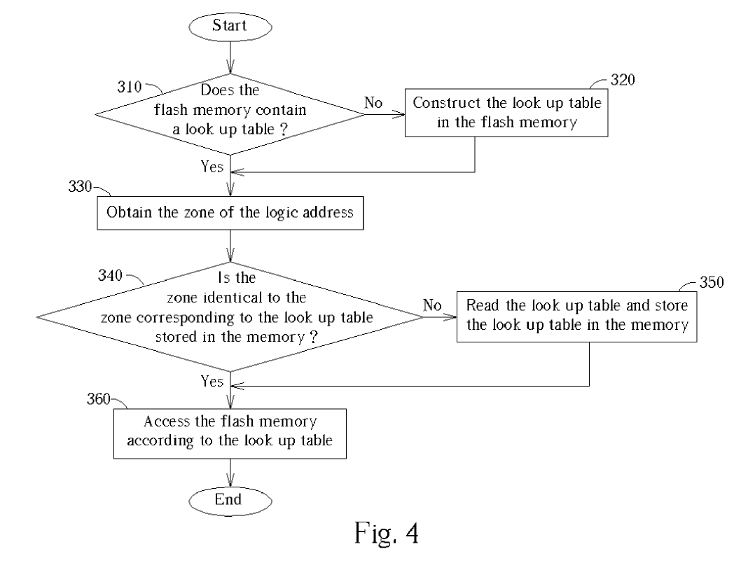

Please refer to FIG. 4. FIG. 4 is a flowchart illustrating a method of accessing the flash memory 30 according to the present invention. When the host 10 accesses the flash memory 30, the look up tables are stored in the spare blocks of the flash memory 30. Since the speed of reading the look up tables stored in the spare blocks of the flash memory 30 is much faster than the speed of constructing new look up tables, the accessing speed is improved. In addition, since the flash memory 30 is nonvolatile, the host 10 only has to construct the look up tables once at the first time. The method of accessing the flash memory 30 according to the present invention includes the following steps:
Step 310: determine if the flash memory 30 contains look up tables of all zones; if not, this generally means that it is the first time the host 10 accesses the flash memory 30, and therefore execute Step 320; if so, this means the flash memory 30 has been accessed by the host 10 before, and the look up tables of all zones are already stored in the spare blocks, thus execute Step 330;
Step 320: the controller 22 of the electronic device 20 reads the address of each block of each zone to construct the look up tables in the memory 24, and stores the look up tables in the spare block of each corresponding zone or in the spare blocks of one certain zone until all the look up tables are constructed and stored in the spare blocks;
Step 330: the controller 22 calculates the zone corresponding to a logic address delivered from the host 10;
Step 340: determine if the zone corresponding to the logic address in Step 330 is identical to the zone corresponding to the look up table stored in the memory 24; if not, execute Step 350, if so, execute Step 360;
Step 350: the flash memory 30 reads the look up table of the zone corresponding to the logic address, and updates the look up table in the memory 24; and
Step 360: the controller 22 accesses the flash memory 30 according to the look up table in the memory 24.

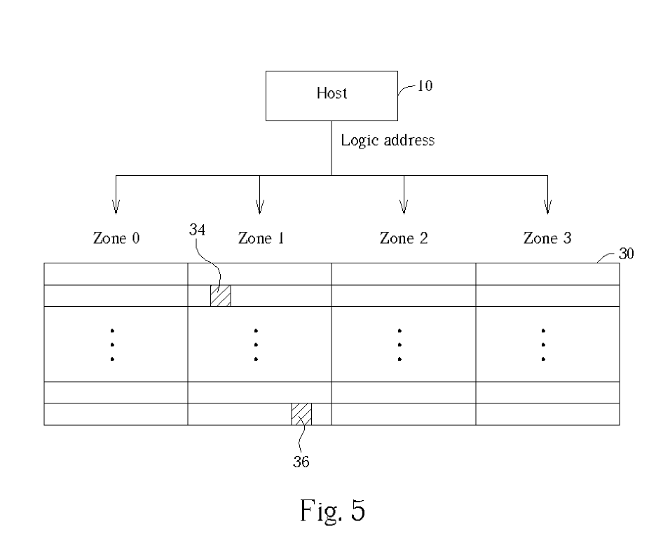

Please refer to FIG. 5. FIG. 5 is a schematic diagram illustrating how the host 10 accesses the flash memory 30. As shown in FIG. 5, a 64 MB flash memory is used as an example. The flash memory 30 is divided into four zones of 16 MB. Each zone has 1024 blocks where 1000 blocks are used as data blocks and the rest 24 blocks are spare blocks. The capacity of each block is 16 KB, and the look up table corresponding to each zone is stored in the spare blocks. Generally, the capacity of a look up is 2 KB, and the look up tables of each zone can be stored in the spare blocks of the corresponding zone, or in the spare blocks of a certain zone. If old data is stored in a first block 34 (data block) of zone 1 of the flash memory 30, the host 10 can read the look up table of zone 1 according to the logic address of the old data, and read the old data from the first block 34 according to the look up table of zone 1 for editing the old data. The new data that has been edited is supposed to replace the old data, however, the flash memory 30 can only be written from “1” to “0” rather than from “0” to “1”. Consequently, a second block 36 (spare block) is therefore used to store new data, and the first block 34 is then erased as a new spare block. Following that the look up table of zone 1 is updated for designating the logic address of the old data to the second block 36. The address of the look up table is changed after the host 10 accesses the flash memory 30, thus each zone requires a corresponding look up table. Normally, it takes hundreds of microseconds to construct a look up table of a zone. Nevertheless, it only takes tens of microseconds to read a look up table constructed in the spare block in advance.

It can be seen that when the host accesses the flash memory, a look up table is required for accessing a corresponding zone of the flash memory. Since the construction of the look up table is time-consuming, to construct the look up tables of all zones of the flash memory in the spare blocks of the flash memory is more efficient. Whenever the zone to be accessed is changed, the controller only has to read the look up table of the zone stored in the spare block. In addition, since the flash memory is nonvolatile, the look up tables only need to be constructed once and can be kept as long as necessary. Though it takes up a little bit of additional space in the flash memory, the accessing speed is critically improved.

In comparison with the prior art, the method of the present invention only has to read the look up table in the spare block of the flash memory when the zone to be accessed is changed. Consequently, the accessing speed is effectively improved from hundreds of microseconds to tens of microseconds. In addition, the look up tables only need to be constructed once at the first time, even when power is interrupted the look up tables are still stored in the spare block since the flash memory is nonvolatile. In short, the method according to the present invention not only saves the time of constructing the look up tables repeatedly but also saves the space of RAM, and thus the accessing efficiency is improved.

Those skilled in the art will readily appreciate that numerous modifications and alterations of the method and device may be made without departing from the scope of the present invention. Accordingly, the above disclosure should be construed as limited only by the metes and bounds of the appended claims.

1. A method of accessing a nonvolatile memory, the nonvolatile memory being installed in an electronic device and comprising a plurality of zones, each zone comprising a plurality of spare blocks, the method comprising the following steps:
(a) storing a look up table of each zone in at least a spare block;
(b) the electronic device obtaining one of the zones of the nonvolatile memory corresponding to a logic address of a host for accessing the nonvolatile memory;
(c) the electronic device reading the look up table of the zone obtained in step (b) from at least one of the spare blocks and storing the look up table in a memory of the electronic device; and
(d) the host accessing the nonvolatile memory according to the look up table stored in the memory of the electronic device.

2. The method of claim 1 wherein the method further comprises determining if the look up table of each zone is stored in the nonvolatile memory.

3. The method of claim 1 wherein the method further comprises determining if the zone obtained in step (b) equals the zone corresponding to the look up table stored in the memory of the electronic device.

4. The method of claim 1 wherein in step (a) the look up table of each zone is stored in at least one of the spare blocks of the zone.

5. The method of claim 1 wherein in step (a) the look up table of each zone is stored in at least one of the spare blocks of the plurality of zones.

6. The method of claim 1 wherein the nonvolatile memory is a flash memory.

7. A device for implementing the method of claim 1.
